(19) United States
(12) Patent Application Publication
(10) Pub. No.: US 2014/0376541 A1
(43) Pub. Date: Dec. 25, 2014

(54) DUAL-TONE MULTI-FREQUENCY (DTMF) PROGRAMMING OF AN AUTO-DIALER

(71) Applicant: Microsoft Corporation, Redmond, WA (US)

(72) Inventors: Manrique Brenes, Laguna Beach, CA (US); Kaido Kert, San Francisco, CA (US); Neil Peter Stevens, London (GB); Simon Robert Wilson, Newbury (GB)

(21) Appl. No.: 13/922,074

(22) Filed: Jun. 19, 2013

(51) Int. Cl. H04L 29/06

(52) U.S. Cl. CPC H04L 65/1059
USPC 370/352

(57) ABSTRACT

In one or more embodiments, a device is configured to automatically contact a Voice-over-Internet Protocol (VoIP) service provider using a communication system that is not native to the VoIP service provider. The device can receive and/or intercept a representation of a first address that is not directed to the VoIP service provider, and generate a representation of a second address effective to contact the VoIP service provider using the representation of the second address. Some embodiments provide an ability to program and/or query a device using telecommunication signaling. In some cases, a service provider can remotely manage firmware and/or software updates to the device using the telecommunication signaling. Alternately or additionally, an end user can manually program information into the device through the telecommunication signaling, such as a predefined address associated with the service provider.

### BACKGROUND

Telephonic communication systems allow a user to connect and converse with other users. When a connection is made, the telephonic communication system transmits voice and/or video between the connected users. Landline communication systems represent a fixed system, in which communications are traditionally sent over a fixed medium, such as a metal wire or fiber optic cable. Conversely, wireless communication systems represent a mobile system in which communications are primarily transmitted using radio waves and/or signals. Companies governing these communication systems typically provide access to the user for an associated fee. Once access is acquired, the user can theoretically communicate with other users interchangeably. For instance, a landline user can communicate with a wireless user, and vice versa.

Voice-over-Internet Protocol (VoIP) provides an alternate, and affordable, communication system in which users communicate voice and/or video using connectivity provided through computers and associated networks, such as the Internet. Users with associated VoIP clients can initiate and receive communication requests with one another, exchange voice and/or video in real-time, and so forth. In general, a user benefits more from VoIP when using broadband data connections that can transfer larger amounts of data. However, some VoIP service providers offer their users additional access to its associated services through landline and/or wireless communication systems where a user dials into the VoIP through these connections. This process not only assumes the user knows how to access the VoIP provider over a landline and/or wireless communication system each time, but additionally involves manual intervention from the user.

### SUMMARY

This Summary is provided to introduce a selection of concepts in a simplified form that are further described below in the Detailed Description. This Summary is not intended to identify key features or essential features of the claimed subject matter.

In one or more embodiments, a device is configured to automatically contact a Voice-over-Internet Protocol (VoIP) service provider using a communication system that is not native to the VoIP service provider. The device can receive and/or intercept a representation of a first address that is not directed to the VoIP service provider, and generate a representation of a second address effective to contact the VoIP service provider using the representation of the second address. Upon establishing a connection with the VoIP service provider, the device can be configured to establish a connection to the first address using the VoIP service provider. In some embodiments, the device can enable authentication of an associated user with the VoIP service provider. Responsive to a successful authentication, the device can establish connections and/or access services via the VoIP service provider. Responsive to an unsuccessful authentication, the device can be configured to disable and/or terminate to a connection to the first address.

Some embodiments provide an ability to program and/or query a device using telecommunication signaling. In some cases, a service provider can remotely manage firmware and/or software updates to the device using the telecommunication signaling. Alternately or additionally, an end user can manually program information into the device through the telecommunication signaling, such as a predefined address associated with the service provider. At times, telecommunication signaling can be used by the service provider to send commands and/or instructions to the device, including commands and/or instructions related to a service account associated with the end user.

### BRIEF DESCRIPTION OF THE DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform the various embodiments described herein.

FIG. 2 is a sequence diagram in accordance with one or more embodiments.

FIG. 3 is a flow diagram in accordance with one or more embodiments.

FIG. 4 is a sequence diagram in accordance with one or more embodiments.

FIG. 5 is a sequence diagram in accordance with one or more embodiments.

FIG. 6 is a sequence diagram in accordance with one or more embodiments.

FIG. 7 is a flow diagram in accordance with one or more embodiments.

FIG. 8 illustrates an example computing device that can be utilized to implement various embodiments described herein.

### DETAILED DESCRIPTION

Overview

In one or more embodiments, a device is configured to automatically contact a VoIP service provider using a communication system that is not native to the VoIP service provider. In some cases, the device utilizes landline and/or wireless communication system infrastructures when contacting the VoIP service provider. Further, a user attempting to establish a communication connection can send a representation of a first address to the device as part of the connection process. In some cases, the representation of the address is sent using telecommunication signaling, such as sending a telephone number via Dual-Tone Multi-Frequency Tones (DTMF). Upon receiving the representation of the first address, the device can generate a representation of a second address and/or send the representation of the second address using telecommunication signaling effective to establish a connection with the VoIP service provider. At times, establishing a connection with the VoIP service provider entails one or more authentication procedures associated with the device and/or an associated user account. Establishing a successful connection with the VoIP service provider can then enable the device to facilitate a communication connection to the first address.

Some embodiments enable a service provider, such as a VoIP service provider, to program the device using telecommunication signaling. For instance, the service provider can update the device with new firmware using the DTMF tones to transmit data and/or commands. Alternately or additionally, the service provider can use telecommunication signaling to query the device for information, such as firmware revision information, hardware version information, associated user information, and so forth. Further, in some embodiments, an end user can program the device with information. For example, an end user can generate DTMF tones associated with input commands to program the device with user-specific information.

In the following discussion, an example environment is first described that may employ the techniques described herein. Example procedures are then described which may be performed in the example environment, as well as other environments. Consequently, performance of the example procedures is not limited to the example environment and the example environment is not limited to performance of the example procedures.

Example Environment

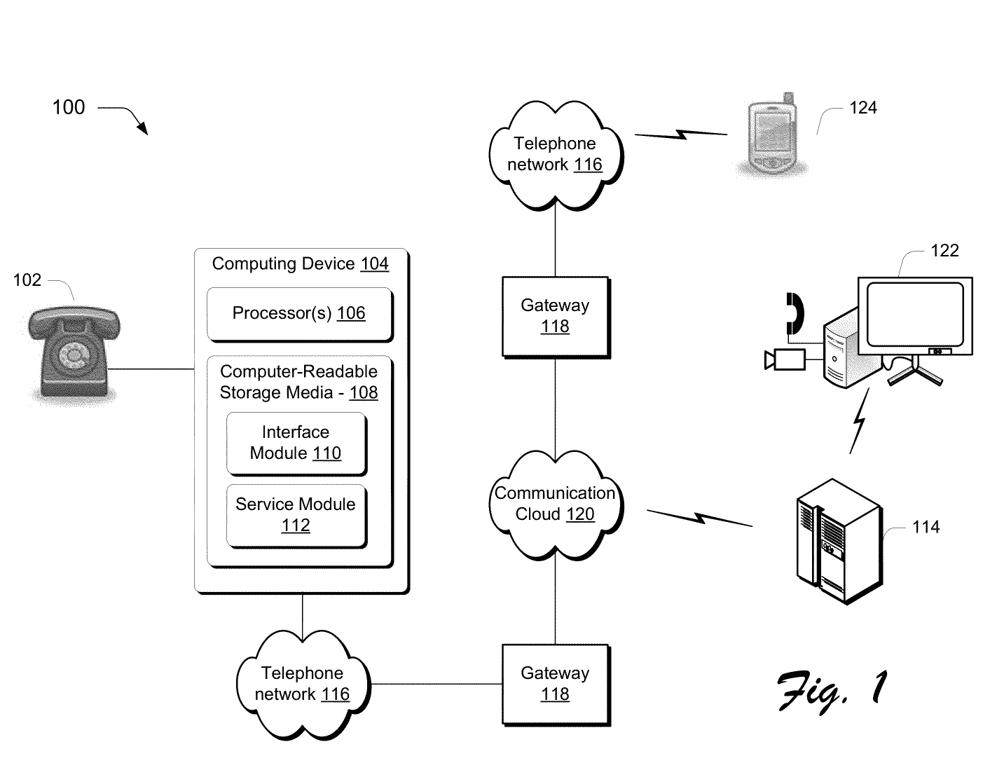

FIG. 1 illustrates an operating environment in accordance with one or more embodiments, generally at 100. Environment 100 includes telephone 102 and computing device 104. Here, telephone 102 and computing device 104 are illustrated as separate components connected through a hardwire connection. However, it is to be appreciated that computing device 104 can be integrated into telephone 102 without departing from the scope of the claimed subject matter. Further, telephone 102 and computing device 104 can be connected in any suitable manner, such as through a telephone cable, RJ11 modular connectors, a wireless link, and so forth.

Computing device 104 includes processor(s) 106, computer-readable storage media 108, an interface module 110 and service module 112 that reside on the computer-readable storage media and are executable by the processor(s). The computer-readable storage media can include, by way of example and not limitation, all forms of volatile and non-volatile memory and/or storage media that are typically associated with a computing device. Such media can include ROM, RAM, flash memory, hard disk, removable media and the like. The functionality provided by the processor(s) 106 and modules 110, 112 can be implemented in other manners such as, by way of example and not limitation, programmable logic and the like. Computing device 104 can be any suitable type of computing device, ranging a complex desktop computing device with multiple-processors, to a simple computing device with lesser processing capabilities, such as an auto-dialer box.

Interface module 110 represents functionality that can receive incoming telecommunication signaling and translate the telecommunication signaling into one or more commands. Alternately or additionally, interface module 110 represents functionality that translates outgoing messages into an appropriate telecommunication signaling format. For example, interface module 110 can receive a series of one or more DTMF tones associated with a Foreign Exchange Office (FXO) interface. Interface module 110 not only understands the interface protocol using the tones, but can additionally translate the series of tones as being associated with a telephone number, a query request, a command message, and so forth. Similarly, interface module 110 can generate any appropriate telecommunication signaling associated with an outgoing message and/or interface. Thus, interface module 110 represents functionality that can receive telecommunication signaling associated with an interface, analyze the incoming telecommunication signaling effective to identify one or more appropriate commands and/or responses, and generate outgoing messages in a format associated with the interface. While described in the context of DTMF tones, it is to be appreciated that any suitable type of telecommunications signaling can be used without departing from the scope of the claimed subject matter, such as telecommunication signaling associated with FXO interfaces, Foreign Exchange Station (FXS) interfaces, Private Branch Exchange (PBX) interfaces, and so forth.

Service module 112 determines and executes functionality in response to the input commands and/or queries identified by interface module 110. Referring to the above example, when interface module 110 identifies a series of telecommunication signaling from telephone 102 as being associated with a telephone number, service module 112 determines an appropriate response. For instance, in some embodiments, service module 112 identifies that an appropriate response to an incoming telephone number and/or address from telephone 102 is to generate telecommunication signals associated with a telephone number and/or address associated with service provider 114 in order to establish a connection to the incoming telephone number. As another example, when interface module 110 identifies a series of telecommunication signaling from service provider 114 as being associated with a firmware update, service module 112 receives and/or updates the firmware as appropriate. Thus, while interface module 110 translates and/or analyzes incoming telecommunication signaling effective to determine input commands and/or messages, as well as generating outgoing messages into appropriate telecommunication signaling, service module 112 responds and/or performs operations associated with the identified commands and/or queries, as further described below.

In order to communicate with external devices, telephone 102 and/or computing device 104 use connections established through telephone network 116, gateway 118, and/or communication cloud 120. In the illustrated embodiment, computing device 104 resides between telephone 102 and telephone network 116, and acts as a bridge between the two entities.

Telephone network 116 generically represents any suitable type of telecommunication system, such as such as to a traditional Public-Switched Telephone Network (PSTN) or other circuit switched network, and/or to a mobile cellular network. Further, telephone network 116 can be any suitable type of network, such as the FXO, FXS, and/or PBX examples discussed above. Here, telephone network 116 is illustrated as being connected to gateway 118 which, in turn, provides telephone network 116 with a connection to communication cloud 120.

Communication cloud 120 represents a packet-based network, such as the Internet, and can comprise a plurality of interconnected elements. In this example, each network element may be connected to the rest of the Internet, and is configured to communicate data with other such elements over the Internet by transmitting and receiving data in the form of Internet Protocol (IP) packets. For simplicity's sake, communication cloud 120 is illustrated here with connections into gateway 118 as well as a connection with service provider 114. These connections can be achieved in any suitable manner, such as a hardwire connection, wireless connection, and so forth.

Service provider 114 represents a server computing device that is configured to provide functionality to other entities, such as computing device 104, telephone 102, computing device 122, mobile device 124, and/or associated users of these devices. In some embodiments, service provider 114 is a VoIP service provider that offers, among other things, voice, video, and/or text services to users via associated hardware (e.g. telephone 102, computing device 104, computing device 122, and/or mobile device 124). For example, a user associated with telephone 102 might wish to establish a voice communication connection with mobile device 124. Instead of utilizing a connection solely managed by telephone network 116, some embodiments direct communications from telephone 102 to mobile device 124 using services provided by service provider 114, as further described below. As illustrated in FIG. 1, service provider 114 can provide services to a variety of users and/or hardware, such as computing device 122 (illustrated here as including an associated telecommunication handset and video) and/or mobile device 124.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

Computing device 104 may also include an entity (e.g., software) that causes hardware or virtual machines of computing device 104 to perform operations, e.g., processors, functional blocks, and so on. For example, the computing device 104 may include a computer-readable medium that may be configured to maintain instructions that cause the computing device, and more particularly the operating system and associated hardware of the computing device 104 to perform operations. Thus, the instructions function to configure the operating system and associated hardware to perform the operations and in this way result in transformation of the operating system and associated hardware to perform functions. The instructions may be provided by the computer-readable medium to the computing device 104 through a variety of different configurations, as further described below.

One such configuration of a computer-readable medium is signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Having described an example environment in which the techniques described herein may operate, consider now a discussion of automatic management of call initiation through a service provider that can utilize the principles described herein.

Automatic Management of Call Initiation Through a Service Provider

Users with home telephone systems or wireless mobile phones typically connect to other telephone devices, mobile phone devices, and/or computing devices by dialing a telephone number associated with a recipient device. For instance, a user can press a sequence of numerical keys on a keypad, where the sequence of numbers is associated with a destination device. In response to the keypad entries, some telephones generate DTMF signaling tones to represent each key selection, and transmit these tones to a corresponding telecommunication system and/or network connected to the telephone device. In turn, the telecommunication system interprets the DTMF tones as a destination address, and manages establishing and maintaining a communication connection between the source and destination devices.

VoIP enables similar communication connections through packet-based networks, such as the Internet. Some Internet-based service providers offer VoIP services to a user, including voice communications as described above, text communications, video communications, and so forth. When a user of the VoIP service provider utilizes a device currently connected to the packet-based network (such as a computer connected to the Internet), access between the device and VoIP service provider reside within a same native environment. In some embodiments, the VoIP service provider offers users outside of the native environment a way to access these same services. For instance, a user utilizing a device connected to a PSTN telecommunication system can first manually dial a telephone number and/or address associated with a VoIP service provider that also has a connection into the PSTN telecommunication system, but resides natively in the packet-based network. Generally speaking, the telephone number dialed by the user to access the VoIP service provider is associated with minimal costs, such as a toll free telephone number or a telephone number that is local to an area code from which the user is dialing. After establishing a connection to the VoIP service provider through the PSTN network, the user then has access to associated services, such a sending and receiving voice communications with a destination device through the packet-based network. However, in order to do so, the user begins by dialing a first telephone number and/or address associated with the VoIP service provider, and then dialing a second number and/or address associated with the destination device once a connection to the VoIP service provider has been established.

Various embodiments provide an ability to automatically connect with a service provider using a communication system that is not native to the service provider. Using the above example of a VoIP service provider, a user can enter a telephone number and/or address associated with a destination device, not being the VoIP service provider, into a telephone device connected to a telecommunication system. In turn, some embodiments identify the telephone number as a destination address and generate telecommunication signaling representing a telephone number and/or address associated with the VoIP service provider effective to establish a connection with the VoIP service provider over the telecommunication system.

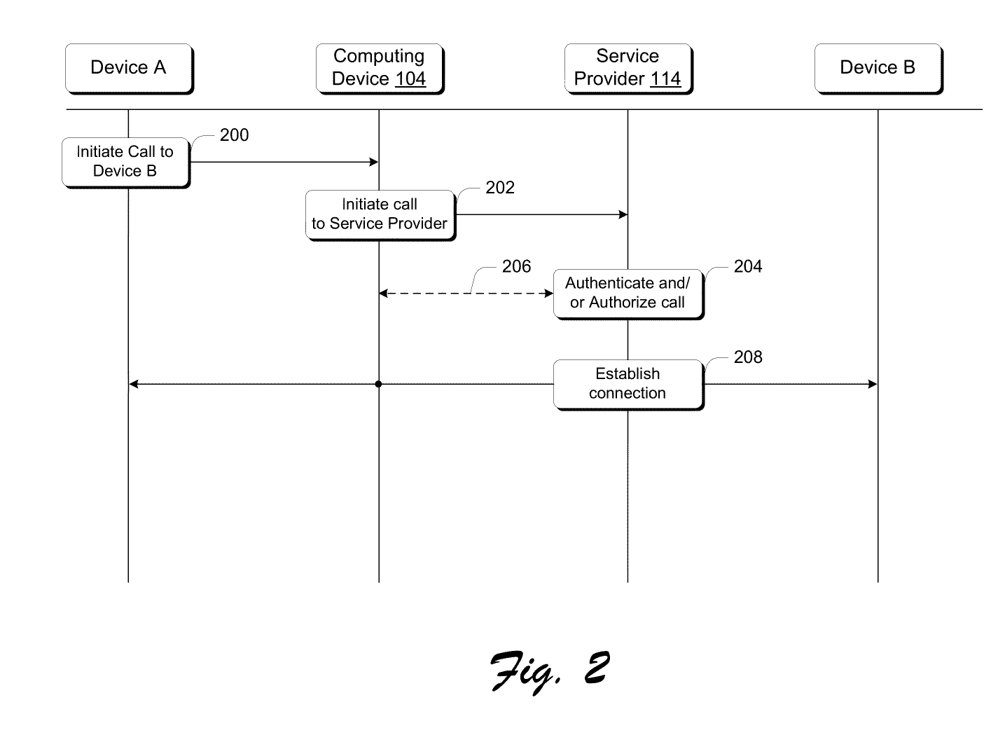

Consider FIG. 2, which illustrates a sequence diagram in accordance with one or more embodiments. In this sequence diagram, interactions between device A, device B, computing device 104 of FIG. 1, and service provider 114 of FIG. 1 are illustrated. Device A represents a device that includes capabilities to initiate a communication connection, as well as transmit and receive data and/or voice over the communication connection. For example, in some embodiments, device A represents telephone 102 of FIG. 1. Alternately or additionally, in some embodiments, computing device 104 represents an auto-dialer computing device.

At step 200, device A initiates a connection to device B. This can be achieved in any suitable manner, such as through generation and transmission of DTMF tones representing a telephone number and/or address associated with device B. In some embodiments, the DTMF tones are transmitted via a hardwire connection. Alternately or additionally, the DTMF tones are transmitted via a wireless connection. However, it is to be appreciated that the connection can be initiated in any suitable manner and can additionally use any suitable signaling format to convey information.

Continuing with the above example, when computing device 104 receives the DTMF tones, it recognizes the series of tones as a call initiation event. In some embodiments, computing device 104 additionally identifies the destination address and/or telephone number associated with the call initiation event. However, instead of initiating a connection to the destination address and/or telephone number (associated here with device B), computing device 104 initiates a connection to service provider 114 at step 204. This can be done automatically and without additional input from the user at the time of the call initiation event. For example, computing device 104 can contain a pre-stored telephone number and/or address associated with service provider 114, as further described below. Upon receiving the call initiation event, computing device 104 generates a new series of telecommunication signaling to communicate the pre-stored telephone number and/or address to an associated telecommunication system. Thus, in the above example, when computing device 104 receives a series of DTMF tones from device A that are associated with a first destination (e.g. device B), computing device 104 instead generates (and transmits) a series of DTMF tones representing an address and/or telephone number associated with service provider 114 to the telecommunication system. In turn, the telecommunication system establishes a connection, whether directly or indirectly, with service provider 114.

In some embodiments, when service provider 114 establishes a communication connection, such as that established with computing device 104, it authenticates and/or authorizes the connection, illustrated here at step 204. At times, an incoming connection request can include information identifying a user and/or account associated with a requesting device. Alternately or additionally, service provider 114 can send one or more queries for information upon receiving the connection request. Any suitable type of information can be included and/or requested, such as an originating address and/or telephone number associated with the requesting device, software and/or firmware revisions associated with the requesting device, and so forth. As part of the authentication process, this information can be used to determine whether the associated user and/or account has appropriate authorization, such as whether an associated account exists, whether the account contains enough monetary credit to pay for charges associated with the requested services, whether support hardware and/or devices (such as computing device 104) contains current software that is compatible and/or requested by service provider 114 for service support, and so forth. Alternately or additionally, the authentication process can be an iterative process, where service provider 114 requests and/or receive additional information from computing device 104, indicated here by dashed line 206.

Upon a successful authentication, service provider 114 establishes a connection between device A and device B at step 208. Here, the connection between service provider 114 and device B is based, at least in part, on utilizing a packet-based network system, while the connection between service provider 114 and device A is based, at least in part, on utilizing a telecommunication system that is different from the packet-based network. While FIG. 2 illustrates the established connection between device A and device B as having direct connections between service provider 114 and/or computing device 104, it is to be appreciated that in some embodiments, these entities act as pass-through entities, and/or simply manage and/or oversee setting up and/or tearing down the connection. Through automatic management of call initiation, a user of device A can utilize services provided by service provider 114 by simply dialing a destination address and/or telephone number. As further described below, the automatic management of call initiation can sometimes utilize preprogrammed information managed by device A and/or a user associated device A, as well as information associated and/or managed by service provider 114.

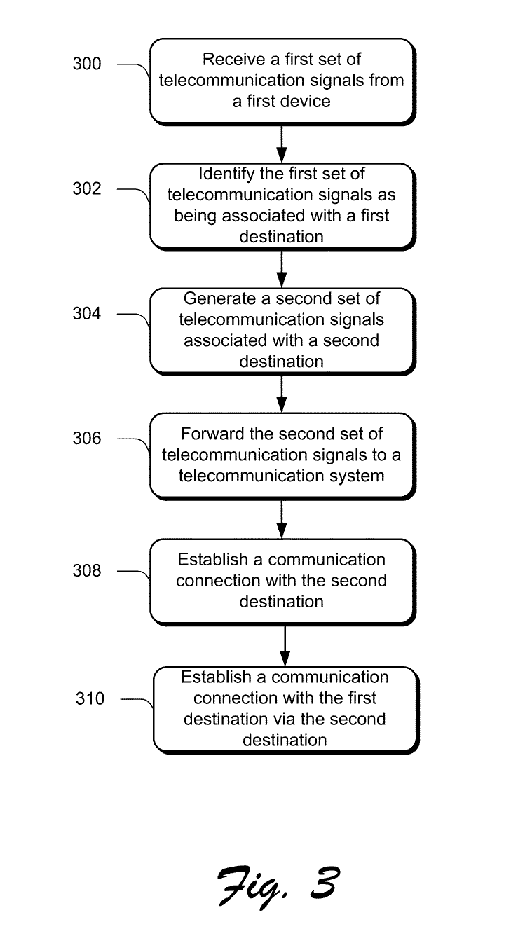

FIG. 3 is a flow diagram that describes steps in a method in accordance with one or more embodiments. The method can be implemented in connection with any suitable hardware, software, firmware, or combination thereof. In at least some embodiments, the method can be implemented by a suitably-configured system such as one that includes, among other components, a interface module and/or service module as that described above.

Step 300 receives a first set of telecommunication signals from a first device. For instance, in some embodiments, the first set of telecommunication signals can be a series of DTMF tones received from a telephone device over a hardwire telephone cable. The first set of telecommunication signals can be representative of any suitable type of information, such as a command, a query, an address and/or telephone number, and so forth.

Step 302 identifies the first set of telecommunication signals as being associated with a first destination, such as a telephone number. Responsive to this identification, step 304 generates a second set of telecommunication signals associated with a second destination. In some embodiments, the second destination is associated with a service provider, such as a VoIP service provider. The second set of telecommunication signals can be configured to include address information associated with the service provider, such as a telephone number. Any suitable signaling format can be used to generate the second set of telecommunication signals, such as DTMF tones described above. In some embodiments, the generated telecommunication signals are in a same signaling format as the first set of telecommunication signals, while other embodiments generate the second set of telecommunication signals using a different signaling format than that of the first set of telecommunication signals.

Step 306 forwards the second set of telecommunication signals to a telecommunication system. For example, the second set of telecommunication signals can be sent on a hardwire connection to the telecommunication system, such as a telephone cable that is connected to an FXO telecommunication network. Alternately or additionally, the second set of telecommunication signals can be transmitted over a wireless connection.

Responsive to forwarding the second set of telecommunication signals to the telecommunication system, step 308 establishes a communication connection with the second destination. In some embodiments, establishing the communication connection can include authentication and or authorization procedures. For instance, when the second destination is a service provider, establishing a connection to the service provider can include one or more iterative exchanges to verify account and/or user verification with the service provider.

Step 310 establishes a communication connection with the first destination via the second destination. For instance, upon establishing a connection with a VoIP service provider, some embodiments establish a connection to the first destination by using services offered by the VoIP service provider. This can be achieved in any suitable manner, such as through forwarding an address, telephone number, and/or other information associated with the first destination to the VoIP service provider effective to enable the VoIP service provider to connect to the first destination.

Having considered a discussion of automatic management of call initiation through a service provider in accordance with one or more embodiments, consider now a discussion of device management through a telecommunication system in accordance with one or more embodiments.

Device Management Through a Telecommunication System

As discussed above, some embodiments provide automatic management of call initiation through a service provider by using a device that resides between a user's telephone and a telecommunication system. Instead of a telephone device connecting directly into the telecommunication system via a telephone cable, the telephone instead uses that same telephone cable to connect with the device. In turn, the device can use a same type of telephone cable to connect into the telecommunication system. When the user dials a telephone number on the telephone, the device receives the dialed input. Using the telecommunication system, the device can then redirect the communications to utilize services of a VoIP service provider in a manner similar to that described above. Provided the device has knowledge of how to reach and understand the VoIP service provider, as well as the telephone device, communications are properly exchanged using the VoIP service provider in an automated manner. However, to facilitate this automation, it is sometimes desirable to update and/or change data stored on the device.

Some embodiments provide an ability to program a device using telecommunication signals. In some embodiments, telecommunication signals can be utilized to download, update and/or store data on the device, such as installing firmware, storing data values, and so forth. For example, a user can program the device with an address and/or telephone number associated with a service provider by using a telephone device connected to the device to generate DTMF tones. Alternately or additionally, a service provider can update firmware in the device using similar and/or alternate telecommunication signaling. Thus, external devices can communicate with the device, whether in a query or command form, utilizing a telecommunication system and/or associated telecommunication signals.

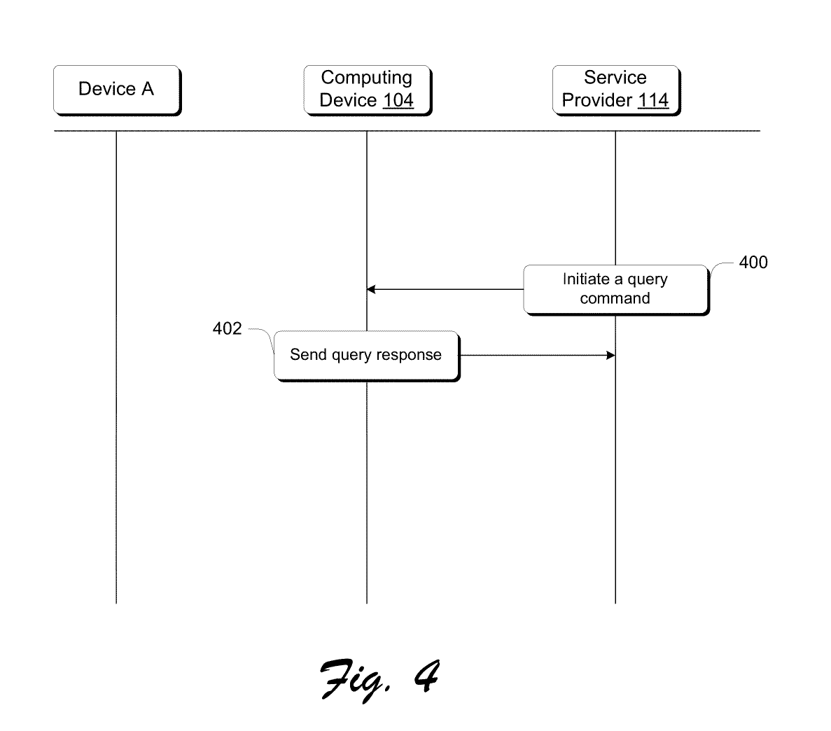

Consider FIGS. 4, 5, and 6 which illustrate varying example sequence diagrams in accordance with one or more embodiments. In these sequence diagrams, interactions between device A, computing device 104 of FIG. 1, and/or service provider 114 of FIG. 1 are illustrated. Device A represents a device that includes capabilities to initiate a communication connection, as well as transmit and receive data and/or voice over the communication connection. For example, in some embodiments, device A represents telephone 102 of FIG. 1. Alternately or additionally, in some embodiments, computing device 104 represents an auto-dialer computing device. While these figures illustrate examples in separate contexts, it is to be appreciated that these concepts can be used interchangeably and in varying order without departing from the scope of the claimed subject matter. Further, for simplicity's sake, the interactions and/or messaging between entities have been illustrated as single steps. However, in implementation, these steps may comprise a plurality of messaging and/or handshaking between entities to accomplish the described functionality.

FIG. 4 illustrates an example sequence diagram in which service provider 114 queries computing device 104 for information. Here, service provider 114 initiates a query command to computing device 104 at 400. This can be achieved in any suitable manner. In some embodiments, computing device 104 and service provider 114 have a connection to an associated telecommunication system. For instance, computing device 104 can connect to the telecommunication system through an FXO interface, while service provider 114 connects to the telecommunication system through a gateway. In some embodiments, service provider 114 directs the telecommunication system to utilize available telecommunication signaling, such as superimposing an Alternating Current (AC) signal onto the line, DTMF tones, etc. to indicate the query command to computing device 104.

At step 402, computing device 104 identifies the query command and sends a query response. For example, in some embodiments, service provider 114 sends a version query to computing device 104, such as hardware version query, software version query and so forth. Upon identifying the query command, computing device 104 returns the requested information. As in the case of service provider 114, computing device 104 utilizes telecommunication signaling available through the associated telecommunication system. Thus, computing device 104 can receive query commands, and respond with information, using telecommunication signaling. In some embodiments, computing device 104 receives query commands and/or forwards information to service provider 114 in a periodic manner. At times, information can be forwarded periodically from computing device 104 without first receiving a query command.

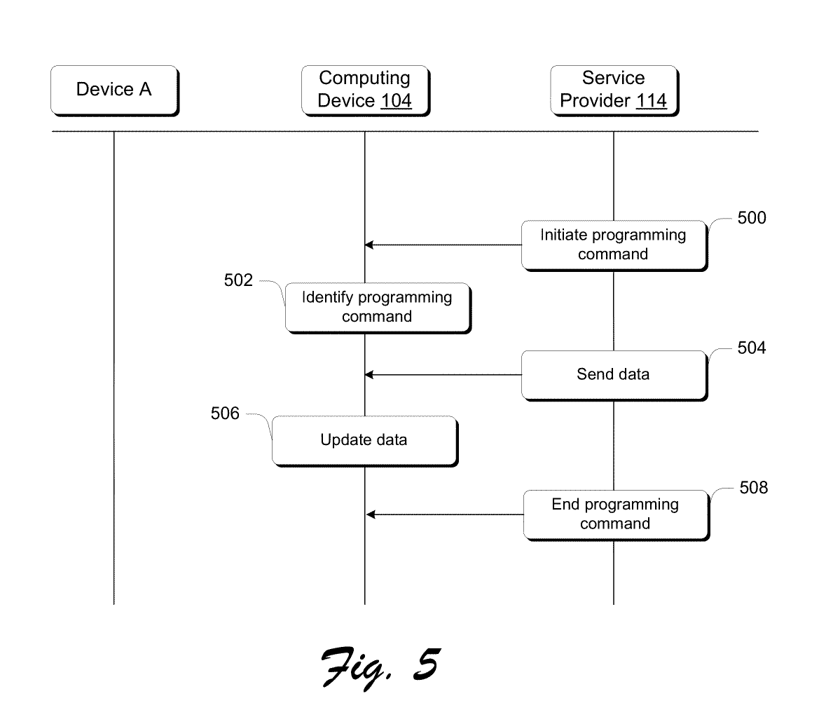

FIG. 5 illustrates an example sequence diagram in which service provider 114 updates firmware, data, and/or other information on computing device. At step 500, service provider 114 initiates a programming command to computing device using telecommunication signaling. This can be achieved in any suitable manner, examples of which are provided above. In some embodiments, the programming command utilizes a different set and/or series of telecommunication signaling than that used for a query command. Thus, through the use of different sequences and/or sets of telecommunication signaling, computing device 104 can distinguish between varying types of input commands and/or queries. While described in the context of a programming command, it is to be appreciated that any other suitable type of command can be sent from service provider 114 to computing device 104 without departing from the scope of the claimed subject matter. For example, in some embodiments, service provider 114 can sent a command and/or message indicating that service has been denied and/or terminated, that authentication of an associated account has failed, and so forth.

At step 502, computing device 104 identifies the programming command. In some embodiments, this causes computing device 104 to transition into a “programming mode”. Here, the phrase “programming mode” is used to describe a transition into a mode where received input is interpreted differently while in this mode, and/or a mode in which computing device 104 is ready to receive, store, and/or install data. In other words, when computing device 104 is in a “programming mode”, it will interpret a same set of received telecommunication signals in a manner differently than when not in “programming mode”. For example, a sequence of DTMF tones that would normally be interpreted as a telephone number might instead be interpreted as a program instruction when in “programming mode”. While not illustrated, in some embodiments, computing device 104 sends, using telecommunication signaling, a confirmation response and/or handshake to service provider 114 as an indication that a transition into “programming mode” has been successful.

At step 504, service provider 114 sends data to computing device 504. This can include any suitable type of transferable data, such as processor-executable instructions, data values, textual strings, and so forth. At step 506, computing device 104 updates the data. In some embodiments, updating the data includes program installation, data storage and/or data replacement, and so forth.

Step 508 represents service provider 114 sending an end programming command. However, this can sometimes come in the form of a timeout at computing device 104 instead of service provider 114 sending an actual end programming command. For instance, if no input is received after a predetermined amount of time, computing device 104 can “time out” and interpret this as an end programming command. Alternately or additionally, service provider 114 can initiate a distinct sequence of telecommunication signaling that is associated with an end programming command. Upon receiving an end programming command, computing device 104 transitions out of “programming mode”. In this manner, service provider 114 can program and/or manage computing device 104 remotely utilizing telecommunication signaling.

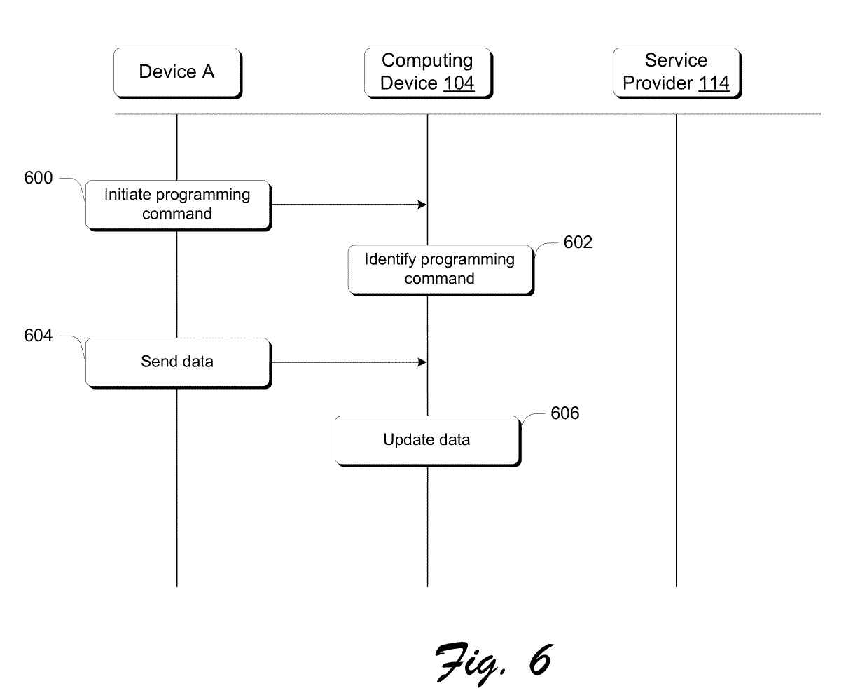

FIG. 6 illustrates an example sequence diagram in which device A updates firmware, data, and/or other information on computing device. At step 600, device A initiates a programming command. For instance, a user can dial a preselected and/or predefined sequence of key pad entries on a telephone device, where the predefined sequence is associated with sending a programming command to computing device 104. In turn, this can generate a set and/or series of telecommunication signals that are transmitted to computing device 104 over a connection, such as DTMF tones over a telephone cable. In some embodiments, the programming command is associated with programming computing device 104 with a destination address and/or telephone number used to access a VoIP service provider. While FIG. 6 is described in the context of a programming command, it is to be appreciated that any suitable command can be used without departing from the scope of the claimed subject matter.

At step 602, computing device 104 identifies the programming command. In some embodiments, the programming command is the same programming command as that used by service provider 114 in FIG. 5 (e.g. a same set of telecommunication signals). In other embodiments, the programming command can be a different programming command than that used by service provider 114 in FIG. 5 to distinguish between programming commands originating at service provider 114 and device A (e.g. a different set of telecommunication signals). In some embodiments, computing device transitions into a “programming mode” as further described above.

At step 604, device A sends data to computing device 104 using telecommunication signaling. This includes sending any suitable type of data, such as data containing address and/or telephone number information associated with a VoIP service provider. Responsive to receiving the data, computing device 104 updates data in its associated memory space with the received data at step 606. Thus, a user of device A can customize and/or program information into computing device 104 using existing telecommunication connections and/or signaling between device A and computing device 104.

While the above scenario diagrams describe interactions between computing device 104, service provider 114, and/or device A in terms of query and programming commands, it is to be appreciated that these techniques can be used in any suitable manner. For example, these command interfaces can be used by a service provider to communicate service termination, communicate an active service, limit what services are accessible through computing device 104, authenticate a user, indicate authentication failures, perform periodic maintenance polling and/or updating, and so forth. As a service provider expands its services, it can automatically update an intermediate device (e.g. computing device 104) to support these expanded services through the use of telecommunication signaling. Similarly, as a user changes physical locations and/or service provider locations, the intermediate device can be programmed by the user to reflect these changes. Thus, at times, the intermediate device can be managed through the use of telecommunication signals.

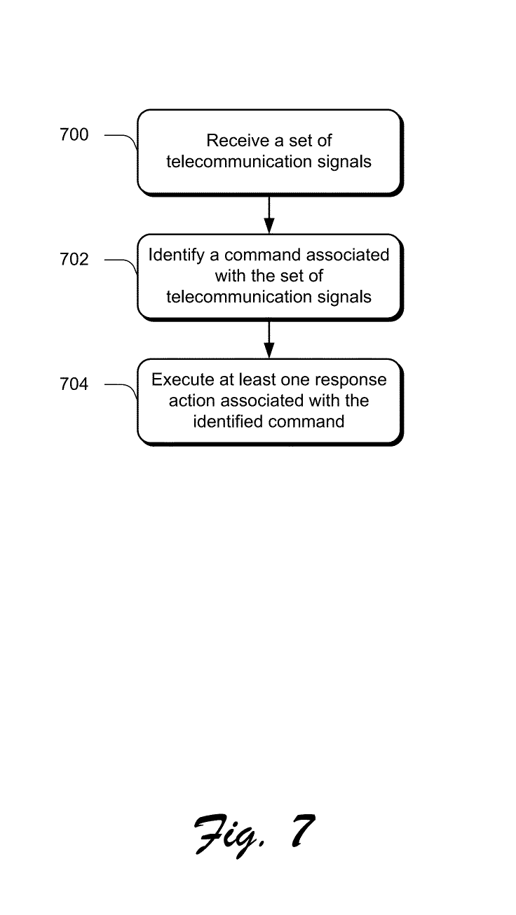

To further illustrate, consider FIG. 7. FIG. 7 is a flow diagram that describes steps in a method in accordance with one or more embodiments. The method can be implemented in connection with any suitable hardware, software, firmware, or combination thereof. In at least some embodiments, the method can be implemented by a suitably-configured system such as one that includes, among other components, interface module 110 and/or service module 112 as described above.

Step 700 receives a first set of telecommunication signals. In some cases, the first set of telecommunication signals originate from a service provider, such as a VoIP service provider. In other cases, the first set of telecommunication signals originate from a connected device, such as telephone device 102 described above. The telecommunication signals can be received in any suitable manner, such as over a hardwire connection or a wireless connection. Further, the telecommunication signals can be any suitable format, examples of which are provided above.

Step 702 identifies a command associated with the set of telecommunication signals. In some embodiments, the command is associated with a query command. Alternately or additionally, the command is associated with an action command.

Responsive to identifying the command, step 704 executes at least one response action associated with the identified command. In some embodiments, the response action includes transitioning into a “programming mode” as further described above. At times, the response action includes returning and/or sending information to a destination, such as the originator of the command and/or a separate entity. As discussed above, returning and/or sending information to a destination can comprise generating one or more telecommunication signals. Alternately or additionally, the response action includes installing executable instructions and/or code, storing data, and so forth, examples of which are provided above. Further, while these steps are described in the context of a single action, it is to be appreciated that these steps can be iterative in nature, and comprise varying combinations of query commands and/or action commands.

Having considered various embodiments, consider now an example system and device they can be utilized to implement the embodiments described above.

Example System and Device

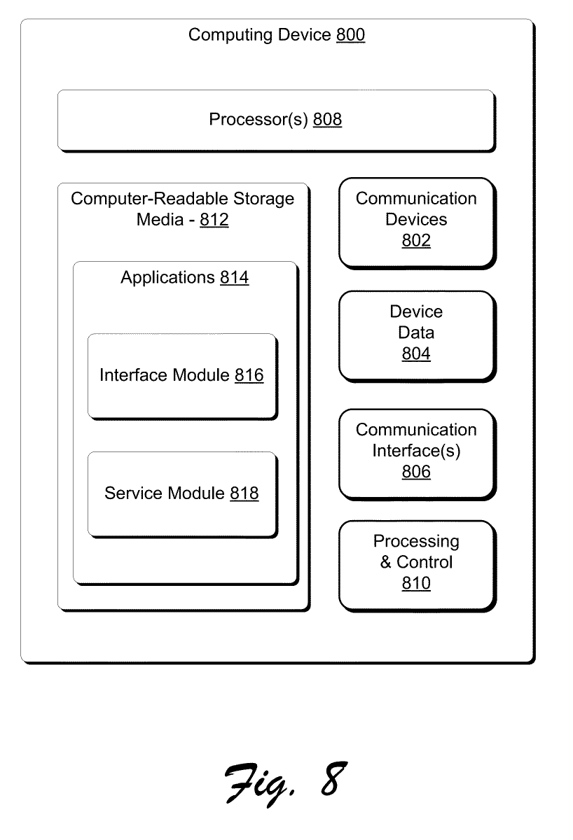

FIG. 8 illustrates various components of an example device 800 that can be implemented as any type of computing device as described with reference to FIGS. 1 and 7 to implement embodiments of the techniques described herein. Device 800 includes communication devices 802 that enable wired and/or wireless communication of device data 804 (e.g., received data, data that is being received, data scheduled for broadcast, data packets of the data, etc.). The device data 804 or other device content can include configuration settings of the device and/or information associated with a user of the device.

Device 800 also includes communication interfaces 806 that can be implemented as any one or more of a serial and/or parallel interface, a wireless interface, any type of network interface, a modem, and as any other type of communication interface. In some embodiments, communication interfaces 806 can include one or more telecommunication system interfaces, such as an RJ11 connector. The communication interfaces 806 provide a connection and/or communication links between device 800 and a communication network by which other electronic, computing, and communication devices communicate data with device 800.

Device 800 includes one or more processors 808 (e.g., any of microprocessors, controllers, and the like) which process various computer-executable instructions to control the operation of device 800 and to implement embodiments of the techniques described herein. Alternatively or in addition, device 800 can be implemented with any one or combination of hardware, firmware, or fixed logic circuitry that is implemented in connection with processing and control circuits which are generally identified at 810. Although not shown, device 800 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 800 also includes computer-readable media 812, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like.

Computer-readable media 812 provides data storage mechanisms to store the device data 804, as well as various applications 814 and any other types of information and/or data related to operational aspects of device 800. The applications 814 can include a device manager (e.g., a control application, software application, signal processing and control module, code that is native to a particular device, a hardware abstraction layer for a particular device, etc.). The applications 814 can also include any system components or modules to implement embodiments of the techniques described herein. In this example, the applications 814 include an interface module 816 and a service module 818 that are shown as software modules and/or computer applications. Interface module 816 is representative of software that is used to interpret incoming communication signals into one or more commands, as well as facilitate generating outgoing communication signals. Service module 818 is representative of software that is used to execute functionality associated with the commands identified by interface module 816. Alternatively or in addition, interface module 816 and/or service module 818 can be implemented as hardware, software, firmware, or any combination thereof

### CONCLUSION

In one or more embodiments, a device is configured to automatically contact a Voice-over-Internet Protocol (VoIP) service provider using a communication system that is not native to the VoIP service provider. The device can receive and/or intercept a representation of a first address that is not directed to the VoIP service provider, and generate a representation of a second address effective to contact the VoIP service provider using the representation of the second address. Upon establishing a connection with the VoIP service provider, the device can be configured to establish a connection to the first address using the VoIP service provider. In some embodiments, the device can enable authentication of an associated user with the VoIP service provider. Responsive to a successful authentication, the device can establish connections and/or access services via the VoIP service provider. Responsive to an unsuccessful authentication, the device can be configured to disable and/or terminate to a connection to the first address.

Some embodiments provide an ability to program and/or query a device using telecommunication signaling. In some cases, a service provider can remotely manage firmware and/or software updates to the device using the telecommunication signaling. Alternately or additionally, an end user can manually program information into the device through the telecommunication signaling, such as a predefined address associated with the service provider. At times, telecommunication signaling can be used by the service provider to send commands and/or instructions to the device, including commands and/or instructions related to a service account associated with the end user.

Although the embodiments have been described in language specific to structural features and/or methodological acts, it is to be understood that the various embodiments defined in the appended claims are not necessarily limited to the specific features or acts described. Rather, the specific features and acts are disclosed as example forms of implementing the various embodiments.

What is claimed is:

1. A computer-implemented method comprising:
receiving, using the computer, a first set of telecommunication signals originating from a Voice-Over-Internet Protocol (VoIP) service provider;
identifying, using the computer, a command associated with the first set of telecommunication signals; and
executing, using the computer, at least one response action associated with the identified command.

2. The computer-implemented method of claim 1 further comprising:
identifying, using the computer, the command associated with the first set of telecommunication signals as a programming command;
transitioning, using the computer, into a programming mode;
receiving, using the computer, at least a second set of telecommunication signals originating from the VoIP service provider; and
installing, using the computer, data associated with the at least second set of telecommunication signals.

3. The computer-implemented method of claim 2, where in the data associated with the second set of telecommunication signals comprises processor-executable instructions.

4. The computer-implemented method of claim 1, wherein the first set of telecommunication signals comprises, at least in part, Dual-Tone Multi-Frequency (DTMF) tones.

5. The computer-implemented method of claim 1, wherein receiving the first set of telecommunication signals further comprises receiving the first set of telecommunication signals using a using a Foreign Exchange Office (FXO) interface.

6. The computer-implemented method of claim 1 further comprising:
receiving, using the computer, a second set of telecommunication signals originating from the VoIP service provider;
identifying, using the computer, the second set of telecommunication signals as a query command; and
sending, using the computer, query response information to the VoIP service provider using a third set of telecommunication signals.

7. A device comprising:
at least one processor;
one or more computer-readable storage memories comprising processor-executable instructions which, responsive to execution by the at least one processor, are configure to enable the device to:
receive telecommunication signals originating from a Voice-Over-Internet Protocol (VoIP) service provider through a first interface;
receive telecommunication signals originating from a device through a second interface;
identify one or more commands by analyzing incoming telecommunication signals via the first interface or the second interface; and
execute at least one response action associated with said identified one or more commands.

8. The device of claim 7, wherein the first interface and second interface comprise Foreign Exchange Office (FXO) interfaces.

9. The device of claim 7, wherein the processor-executable instructions are further configured to:
identify a first set of telecommunication signals received via the second interface as a programming command;
identify a second set of telecommunication signals received via the second interface as an address; and
store the address in the computer-readable storage memories.

10. The device of claim 9, wherein the address comprises a telephone number associated with the VoIP service provider.

11. The device of claim 10, wherein the processor-executable instructions are further configured to:
receive a third set of telecommunication signals via the second interface;
identify the third set of telecommunication signals as a second address;
generate a fourth set of telecommunication signals associated with the telephone number; and
send the fourth set of telecommunication signals via the first interface.

12. The device of claim 11, wherein the processor-executable instructions to generate the fourth set of telecommunication signals are further configured to automatically generate the fourth set of telecommunication signals without additional input from the second interface.

13. The device of claim 7, wherein the processor-executable instructions are further configured to:
receive a first set of telecommunication signals originating from the VoIP service provider via the first interface;
identify the first set of telecommunication signals as a programming command;
transition into a programming mode;
receive at least a second set of telecommunication signals originating from the VoIP service provider via the first interface; and
install the second set of telecommunication signals as program instructions based, at least in part, on the transition into the programming mode.

14. The device of claim 7, wherein the processor-executable instructions are further configured to:
receive a first set of telecommunication signals originating from the VoIP service provider via the first interface;
identify the first set of telecommunication signals as being a query command;
generate a second set of telecommunication signals, the telecommunication signals configured to include query response information; and
send the second set of telecommunication signals through the first interface.

15. The device of claim 14, wherein the query command is associated with an authentication process.

16. The device of claim 7, wherein at least some of the telecommunication signals comprise Dual-Tone Multi-Frequency (DTMF) tones.

17. One or more computer-readable storage memories comprising processor-executable instructions which, responsive to execution by the at least one processor, are configure to enable the device to:
receive telecommunication signals originating from a Voice-Over-Internet Protocol (VoIP) service provider through a first interface;
identify one or more commands by analyzing the telecommunication signals; and
execute at least one response action associated with said identified one or more commands.

18. The one or more computer-readable storage memories of claim 17 wherein the processor-executable instructions are further configured to receive telecommunication signals originating from a device through a second interface.

19. The one or more computer-readable storage memories of claim 18, wherein the processor-executable instructions are further configured to:
identify a first set of telecommunication signals received via the second interface as a programming command;
identify a second set of telecommunication signals received via the second interface as an address; and
store the address in the one or more computer-readable storage memories.

20. The one or more computer-readable storage memories of claim 17, wherein the processor-executable instructions are further configured to:
receive a first set of telecommunication signals originating from the VoIP service provider via the first interface;
identify the first set of telecommunication signals as a programming command;
transition into a programming mode;
receive at least a second set of telecommunication signals originating from the VoIP service provider via the first interface; and
install the second set of telecommunication signals as program instructions based, at least in part, on the transition into the programming mode.
